(19) United States
(12) Patent Application Publication
(10) Pub. No.: US 2014/0257696 A1
(43) Pub. Date: Sep. 11, 2014

(54) Travel Pattern Analysis

(71) Applicant: Kamal Zamer, Austin, TX (US)

(72) Inventor: Kamal Zamer, Austin, TX (US)

(21) Appl. No.: 13/788,527

(22) Filed: Mar. 7, 2013

(51) Int. Cl. G01C 21/00

(52) U.S. Cl. CPC G01C 21/00
USPC 701/537; 701/300

(57) ABSTRACT

Methods and systems are provided for analyzing a user's travel pattern to determine alternative routes that may benefit the user. One or more alternative routes may have places of interest to the user therealong. Interests of the user can be determined, such as from purchase histories, wish lists, and likes. For example, the user's purchase history can indicate that the user surfs. In this instance, the user can be notified that a new surf shop just opened one block off of the user's regular route to and from work.

### BACKGROUND

1. Technical Field

The present disclosure generally relates to electronic commerce and, more particularly, relates to methods and systems for analyzing travel patterns to encourage consumer exploration and spending.

2. Related Art

People often travel a considerable amount during their typical work day. It has been estimated that the average American driver travels about 30 miles per day. Such driving includes to and from work, as well as trips for lunch and running errands. Much of a typical person's daily drive is routine. That is, the typical person tends to drive the same route each day. Generally, the person will drive the same route to and from work. Even if the person often drives somewhere for lunch, the person will generally eat at a limited number of different places. Thus, people tend not to stray from their regular driving routes.

People can have many different interests. Such interests can include hobbies, sports, music, reading, dining, watching movies, and many other activities. Stores abound for catering to the interests of people. In many cities, various stores can generally be found that cater to the interest of people. For example, many cities have a plurality of hobby shops, sporting goods stores, music stores, book stores, restaurants, and the like.

People often consult directories, the Internet, and friends when they are searching for stores or other places that cater to their interest. Generally, these sources are satisfactory in providing information regarding such stores.

### BRIEF DESCRIPTION OF THE DRAWINGS

FIG. 1 is a block diagram of a system for travel pattern analysis, according to an embodiment;

FIG. 2 is a flow chart showing a method for travel pattern analysis, according to an embodiment;

FIG. 3 is a flow chart showing further detail of the method for travel pattern analysis, according to an embodiment; and

FIG. 4 is a block diagram of an example of a computer that is suitable for use in the system for travel pattern analysis according to an embodiment.

### DETAILED DESCRIPTION

Much of a typical person's daily drive is routine. That is, the typical person tends to drive the same route each day. Generally, the person will drive the same route to and from work. Often, if the person drives somewhere for lunch, the person will tend to eat at a limited number of places. Because the typical person's daily drive is so routine, the typical person is not exposed to many nearby places that may be of interest to that person. By following substantially the same route every day, the person is rarely exposed to new stores, restaurants, theaters, parks, or other places of interest.

As mentioned above, people often consult directories, the Internet, and friends when they are searching for stores or other places of interest to them. Generally, such sources of information are satisfactory in providing such information. However, such sources are typically only consulted with a person is actively seeking information regarding stores or other places of interest.

In many instances, a person will visit a store or other place of interest as long as the place is not too far off of the user's regular route. People are generally curious and typically consider it worthwhile to visit such places as long as it is not too inconvenient for them to do so. However, the person must generally be aware of such places in order to make the effort to visit them.

According to an embodiment, one or more alternative routes are provided as alternatives to one or more of a user's regular routes, such as to and from work. Places of interest to the user can be found along the alternative routes or along a user's regular route. The user can be informed of such places and can visit them, as desired.

According to an embodiment, the user's travel patterns can be analyzed. The analysis can provide the alternative routes. The alternative routes can be similar to the original route. Therefore, places of interest along the alternative routes or new places along the regular route can generally be convenient for the user to visit. The user's purchase history, wish lists, likes, and such can be used to define the places of interest along the alternative or regular routes.

The user's purchase history can be present on various websites, as well as in the user's mobile device. For example, the user's purchase history can be present on merchant websites where the user does online shopping. The user purchase history can be present on payment facilitator websites that facilitate the user's online shopping. For example, the user's purchase history can be present on a payment provider website, on a credit card website, on a bank website, or the like.

The user's wish lists can be present on various websites. For example, the user's wish lists can be present on merchant websites where the user does online shopping. The user's wish lists can be present on social networking. The user's wish lists can be present on various other websites, as well as in the user's mobile device.

People often list their interests on social websites, blogs, and the like. For example, a person can “like” products that they have purchased and are satisfied with. Such liked products can be listed on the person's social website to provide recommendations for others. People often discuss their interest in emails, text messages, and the like. Such websites, blogs, emails, text messages, and the like can be sources of information regarding the user's interests. Such information can be obtained from a user device, server, or any other device or system.

According to an embodiment, purchase histories, wish lists, likes, as well as information from blogs, emails, text messages, and the like can be used to determine the user's interests. The user's interests can be used to identify stores, restaurants, parks, and other places of interest to the user along the alternative routes. The user can be informed of the alternative routes and the places of interest therealong. Generally, the user will be willing to explore new places as long as they are consistent with the user's interest and are not too far out of the way, e.g., are not too inconvenient to travel to. In this manner, the user can be made aware of places that can benefit the user.

According to an embodiment, a travel pattern engine or travel pattern analysis system can analyze the user's typical travel route by utilizing a Global Positional System (GPS) on a device of the user, such as the user's smartphone. After sufficient travel information has been collected (for example, several days of travel information), the travel pattern system determine alternative routes from a common travel origin of the user to a common travel destination of the user and/or vice versa and amount of time spent at various locations along the route. Such alternative routes can satisfy the user's desire to get to their destination in a timely manner.

The travel pattern system can look for places of interest to the user along the original route and along each of the alternative routes. The travel pattern system can look for places of interest to the user within a given distance, e.g., a few blocks, of the original route and within a given distance of each of the alternative routes. The user can specify a maximum number of alternative routes and/or the given distance, such as in a setup process or substantially in real-time.

The user can provide a list of known places of interest. In this manner, the user can avoid being informed of places of which the user is already aware. This can be done during a setup procedure or at any other time.

The alternative routes can be parallel roads, roads of a similar type with respect to the original route, similar subway lines, similar avenues, similar sidewalks, similar walkways, and the like. The alternative routes can be substantially dissimilar with respect to the original route. For example, the original route can be a bus route and the alternative route can be a walking route. Any combination of types of routes can be provided as the original route and/or the alternative route. The user can specify types of alternative routes to consider, such as in a setup process or substantially in real-time. Thus, the travel pattern system can only consider driving routes, for example.

Searching for places of interest within a small initial area will give the user a list of places that are very easy and convenient to visit. It will encourage the user to explore and maybe find something new they can add to their routine. Once the user is comfortable with exploring the small initial area, then the search area for places of interest can be expanded. The user can specify the size and/or location of the area within which to determine alternative routes and/or find places of interest, such as in a setup process or substantially in real-time.

According to an embodiment, the travel pattern engine can cooperate with a recommendation engine to define the travel pattern analysis system. Thus, the travel pattern analysis system can learn and use a user's likes, interests, and preferences so as to allow the travel pattern system to provide recommendations for places of interest to the user. In this manner, the recommendation can be based on things in which the user has already expressed an interest.

Interest can also be inferred. For example, a user may spend two hours at a nice restaurant on the way home from work. The user may typically spend a certain dollar amount or range for dinners, with Friday dinners generally being especially expensive. From this, an inference may be made that the user would like to go to a nice restaurant for dinner on Fridays after work. As such, a recommendation may be made to the user of a similar category or type of restaurant, along the same route or an alternate route.

Similarly, if the user spends about forty minutes at a sports memorabilia shop on most Saturday mornings, it can be inferred that the user is interested in sports memorabilia. Thus, a different sports memorabilia shop along either the user's regular route or along an alternative route can be recommended to the user.

If the user shops at a particular department store around Christmas, it can be inferred that the user purchases Christmas gifts there. A department store of the same or a different company that is along the user's regular route or along an alternative route can be recommended to the user prior to Christmas, prior to another holiday, prior to a birthday, or at any other time that the user would like to purchase a gift (such as at a time specified by the user).

If there is insufficient or no information available regarding the user's interest, the travel pattern analysis system can suggest places of interest and have the recommendation engine learn from the user's feedback. Such places can be places of general interest. Such places can be places of interest to people having similar demographics with respect to the user. Such places can be places of interest to friends of the user. Thus, proxies of the user can be provided when insufficient information is not available regarding the user. Even if there is sufficient information available regarding the user's interest, places of general interest and/or of interest to the user's friends can be suggested to the user.

In any event, the travel pattern analysis system can learn from comments or feedback provided by the user. Thus, the travel pattern analysis system can use artificial intelligence to refine such recommendations or suggestions. Heuristics can be used to provide such recommendations or suggestions. Thus, as the travel pattern analysis is used more, the accuracy of its recommendations can be enhanced.

According to an embodiment, use of the travel pattern analysis system can be made game like. This can be done, for example, to encourage a hesitant user to take advantage of the travel pattern analysis system. Badges, points, or other awards can be offered for performing various tasks. Merchant incentives can be associated with the awards. Thus, a user who achieves a particular award can be eligible for a corresponding merchant incentive. For example, awards can be given for completing your first exploration of a point of interest, bringing more than one person to the point of interest, reviewing the point of interest, sharing the point of interest, visiting a specific point of interest multiple times, traveling a certain distance to reach a point of interest, and the like. Merchants can benefit from increased exposure and traffic. Thus, merchants have motivation to provide substantial incentives to users.

Analyzing a person's travel patterns can provide insights regarding which locations a user is more likely to learn more about, which locations a user is more likely to visit, and at which location a user is more likely spend time. If a person is recommended a place that is good, but is far from their usual travel pattern, they are probably more likely to not visit the place. The travel pattern analysis system provides users the opportunity to discover the world around them using locations which are close to their usual, comfortable routine, e.g., route.

The one or more hardware processors can be in communication with the one or more memories. The one or more hardware processors can be operable to receive a first communication that includes an indication of a user's travel pattern. The one or more hardware processors can determine, at least in part from the user's travel pattern, places of interest to the user proximate the user's travel pattern. The one or more hardware processors can send a second communication to the user including an indication of what the places of interest are and where the places of interest are located.

The one or more memories and one or more hardware processors can be part of the same device, e.g., server. The one or more memories and one or more hardware processors can be part of the different devices, e.g., servers. The one or more memories and one or more hardware processors can be co-located. The one or more memories and one or more hardware processors can be located in different places, e.g., different rooms, different buildings, different cities, or different states.

Determining the places of interest to the user can comprise determining at least one alternative route with respect to the user's travel pattern. As many alternative routes as exist can be determined. Fewer than as many alternative routes as exist can be determined. Various criteria can be used to eliminate potential alternative routes from those that exist. Only alternative routes that meet such criteria can be considered as having places of interest to the user.

For example, the criteria can be drive time. Thus, determining the at least one alternative route to the user's travel pattern can comprise determining at least one alternative route to the user's travel pattern that increases a drive time of the user by less than a predetermined amount. Similarly, distance can be the criteria. Thus, determining the at least one alternative route to the user's travel pattern can comprise determining at least one alternative route to the user's travel pattern that increases a distance traveled by user by less than a predetermined amount. Any combination of criteria can be used. The user can provide the criteria, such as during a setup process for the travel pattern analysis system. The user can provide or modify the criteria substantially in real-time, such as via the app.

At least one place of interest along the at least one alternative route can be determined. Any routes that lack at least one place of interest can be discarded (not communicated to the user). Many places of interest along each alternative route can be communicated to the user as can be determined by the travel pattern analysis system. Thus, one, two, three, four, five, or more places of interest along each alternative route can be communicated to the user.

A list of places of interest along each alternative route can be communicated to the user. The user can modify the list. The user can add to or delete from the list. The user can vary an order of the list. For example, the user can prioritize the list to reflect the order in which the user wishes to visit the places on the list.

Determining the at least one place of interest along the at least one alternative route can comprise determining the user's travel pattern. The user's travel pattern can be determined using a GPS enabled mobile device of the user. The first communication can be sent to the one or more processors by the GPS enabled mobile device.

An app can be used to determine the user's travel pattern. The app can monitor the user's travel for a predetermined amount of time. For example, the app can monitor the user's travel for one, two, three, four, five, six, seven, or more days. The app can monitor the user's travel for one, two, three, four, five, six, or more weeks. The app can monitor the user's travel for any desired amount of time. The user can determined the amount of time for which the user's travel is monitored, such as during the setup process.

The user can provide, such as via the app, all or a portion of the user's travel pattern. Thus, the user can specify the user's travel pattern. The user can specify all or a portion of the user's travel pattern using a map, such as a map provided by the app. For example, the user can trace a route corresponding to the users travel pattern on the map. The map can comprise one of the maps 116, one of the maps 128, one of the maps 136, and/or one of the maps 156, for example.

The user's travel pattern can be an average of a plurality of routes that the user commonly travels. The user's travel pattern need not correspond to any particular route that the user travels or that can be traveled. For example, the user's travel pattern can include one or more portions that are not on roadways, e.g., that are between roadway or are otherwise across areas that cannot easily be traveled (such as over bodies of water, ravines, buildings, and the like). The user's travel pattern can indicate a path without indicating a path can or should be traveled. The user's travel pattern need not be a travelable route in order to be used to define the alternative routes. The user's travel pattern can be the route that the user travels.

According to an embodiment, a method can comprise storing, such as in one or more memories, information about an account of a user; receiving, such as via one or more hardware processors, a first communication including an indication of a user's travel pattern; determining, such via the one or more hardware processors, at least in part from the user's travel pattern, places of interest to the user proximate the user's travel pattern; and sending, via the one or more hardware processors, a second communication to the user including an indication of what the place of interest are and where the places of interest are located. The method can be practiced on a device of the user, a device of a merchant, a device of a payment processor, a device of a social network, and/or any other device.

The one or more memories can store information about an account of a user. The one or more memories can be one or memories of a merchant device, one or more memories of a user device, and/or one or more memories of a server. The one or more memories can be one or memories of any device, system, entity, or combination thereof.

The one or more memories can store information regarding interests of the user. For example, the one or more memories can store information such as a purchase history of the user, a wish list of the user, or likes of the user. The one or more memories can store information regarding interests of the user that is provided by the user. For example, the user can provide a list of interests.

According to an embodiment, a computer program product can comprise a non-transitory computer readable medium having computer readable and executable code for instructing one or more processors to perform a method. The method can comprise storing information about an account of a user; receiving a first communication including an indication of a user's travel pattern; determining at least in part from the user's travel pattern, places of interest to the user proximate the user's travel pattern; and sending a second communication to the user including an indication of what the place of interest are and where the places of interest are located. Example of such computer readable media can include hard disks, tape, optical disks, and solid state disks.

According to an embodiment, a computer program product can comprise a non-transitory computer readable medium. The non-transitory computer readable medium can have computer readable and executable code for instructing one or more processors to perform any of the methods disclosed herein.

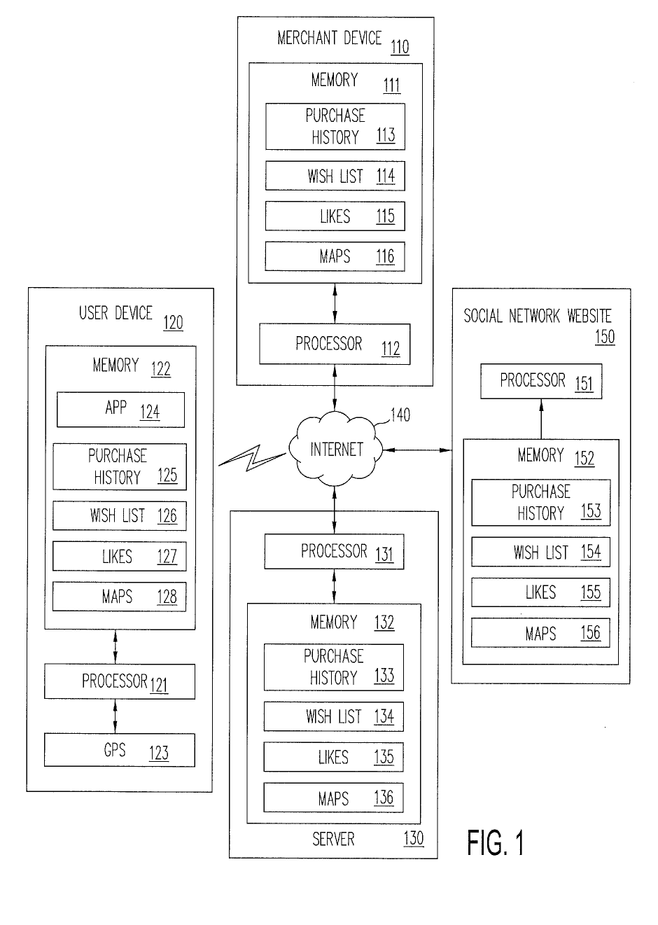

FIG. 1 is a block diagram of a system for travel pattern analysis, according to an embodiment. The system can include a merchant device 110, a mobile device 120, a payment server 130 and/or a social network 150. The functions discussed herein can be split and/or shared amount the merchant device 110, the mobile device 120, the payment server 130, and/or the social network 150, as disclosed desired.

The merchant device 110 can comprise a merchant checkout terminal, a computer, and/or a server, for example. The merchant device 110 can include a memory 111 and a processor 112. The memory 111 can store a purchase history 113, a wish list 114, likes 115, and/or maps 116. The purchase history 113, the wish list 114, the likes 115, and/or the maps 116 can be used to determine places of interest to the user proximate the user's travel pattern, as disclosed herein. The merchant device 110 can be used for processing purchases from the merchant. The merchant device 110 can be used for making or processing sells and/or payments. The merchant device 110 can be used to determine places of interest to the user proximate the user's travel pattern, as disclosed herein.

The mobile device 120 can be carried by the user. The mobile device 120 can comprise a cellular telephone, a smart telephone, a hand held computer, a laptop computer, a notebook computer, or a tablet computer, for example. The mobile device 120 can include a processor 121, a memory 122, and a global positioning system (GPS) 123. The memory 122 can store an app 124, a purchase history 125, a wish list 126, likes 127, and/or maps 128. The app 124, the purchase history 125, the wish list 126, the likes 127, and/or the maps 128 can be used to determine places of interest to the user proximate the user's travel pattern, as disclosed herein.

The mobile device 120 can be used for routine telephone calls, text messaging, web browsing, and the like. The mobile device 120 can be used for to determine places of interest to the user proximate the user's travel pattern. The app 124 can be stored in the memory 122 and executed by the processor 121. The app 124 can be used to determine places of interest to the user proximate the user's travel pattern.

The server 130 can comprise a server of a payment provider, such as Paypal, Inc. The server 130 can be a single server or can be a plurality of servers. The server 130 can include one or more processors 131 and a memory 132. The memory 132 can store a purchase history 133, a wish list 134, likes 135, and/or maps 136. The purchase history 133, the wish list 134, the likes 135, and/or the maps 136 can be used to determine places of interest to the user proximate the user's travel pattern, as disclosed herein.

The memory 132 can be a memory of the server 130 or a memory that is associated with the server 130. The memory 132 can be a distributed memory. The memory 132 can store a user account 133 and a merchant account 134. The server 130 can be used for payment processing, social networking, and/or can be used to determine places of interest to the user proximate the user's travel pattern, as disclosed herein.

A social network website 150 can comprise a processor 151 and a memory 152. The memory 152 can store a purchase history 153, a wish list 154, likes 155, and/or maps 156. The purchase history 153, the wish list 154, the likes 155, and/or the maps 156 can be used to determine places of interest to the user proximate the user's travel pattern, as disclosed herein.

Generally, the merchant device 110, the mobile device 120, the payment server 130, and the social network website 150 can perform the functions discussed herein. That is, at least to some extent, a function that is discussed herein as being performed via one of these devices can be performed by a different one of these devices or by a combination of these devices.

The merchant device 110, the mobile device 120, the server 130 and/or the social network website 150 can communicate with one another via a network, such as the Internet 140. The merchant device 110, the mobile device 120, and the server 130 can communicate with one another via one or more networks, such as local area networks (LANs), wide area networks (WANs), cellular telephone networks, and the like. The merchant device 110, the mobile device 120, the social network 150, and the server 130 can communicate with one another, at least partially, via one or more near field communications (NFC) methods or other short range communications methods, such as infrared (IR), Bluetooth, WiFi, and WiMax.

Purchase histories are often maintained by various websites and generally provide an indication of what products the user has purchased and when the products were purchased. Other information, such as the cost of the products, the shipping methods used, and the actual deliver date can be included. The purchase history can be a purchase history of a merchant (such as of a merchant website), a purchase history of a payment facilitator (such as of a payment provider, a credit card company, a bank, or the like), a purchase history of a user device (such as a purchase history maintained by an app of the user device), a purchase history of a social networking website, or any other purchase history or combination of purchase histories.

Wish lists are often maintained by various websites and generally provide an indication of what products the user would like to purchase in the future. Products are typically added to a wish list by the user, such as when the user is considering the purchase of a product but is not ready to purchase the product. The wish list can be a wish list of a merchant (such as of a merchant website), a wish list of a payment facilitator (such as of a payment provider, a credit card company, a bank, or the like), a wish list of a user device (such as a wish list maintained by an app of the user device), a wish list of a social networking website, or any other wish list or combination of wish lists.

Likes are often maintained by various websites and generally provide an indication of what products the user would like to purchase in the future. Products are typically liked by the user after the user tries the products, such as after purchasing the products. A product is liked if the user enjoys using the product and wants to recommend the products to friends. Typically, products that have been liked by a user are provided on a website for others to view.

Likes can be listed on a social networking website. Likes can be listed on any other website, such as a merchant website or a payment facilitator website. Likes can be listed a user device (such as by an app of the user device).

Purchase histories, wish lists, and likes can provide reliable indications of the interests of the user. Other indications of the interests of the user can be used to determine places of interest to the user. For example, emails to and from the user can be searched to identify products, restaurants, or anything else that may be of interest to the user. Information regarding interest of the user may be obtained from any source and can be used to determine places of interest to the user.

Determining at least one place of interest along the at least one alternative route can comprise accessing the purchase history, the wish list, and/or the likes of the user to determine interests of the user. The interests of the user can be provided by the user, the user's friends and/or the user's family. The interests of the user can be provided explicitly (such as in a list) by the user, the user's friends and/or the user's family. The interests of the user can be inferred from activities (such as likes, purchases, travel habits, emails, texts, etc.) of the user, the user's friends and/or the user's family.

FIG. 1 illustrates an exemplary embodiment of a network-based system for implementing one or more processes described herein. As shown, the network-based system may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or another suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

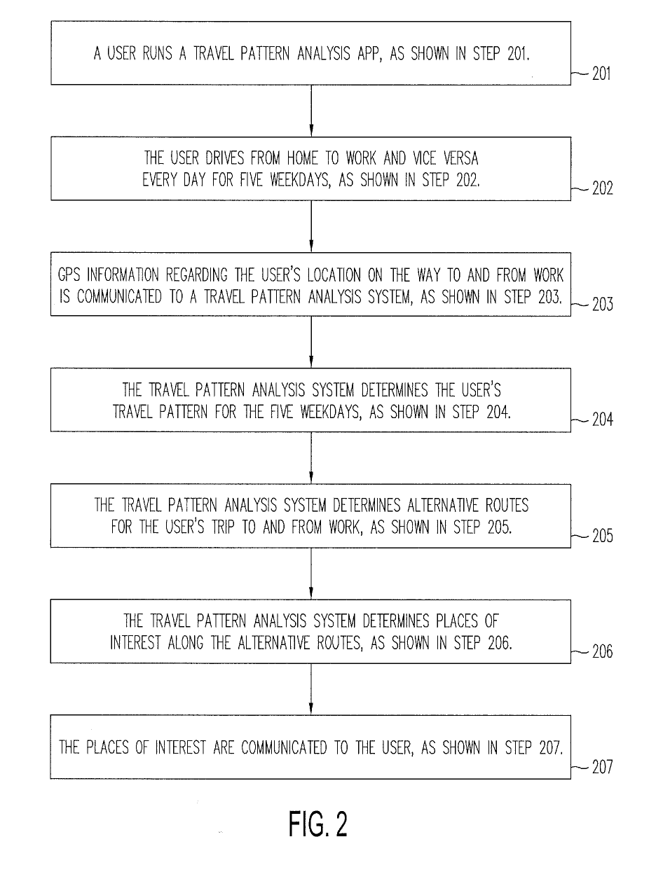

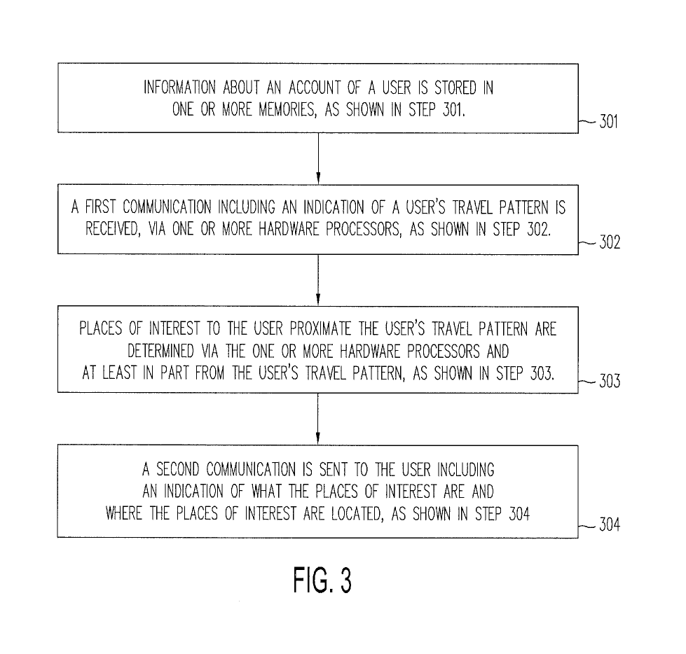

FIGS. 2 and 3 are flow charts that describe examples of operation of the system for travel pattern analysis according to embodiments thereof. Note that one or more of the steps described herein may be combined, omitted, or performed in a different order, as desired or appropriate.

FIG. 2 is a flow chart showing a method for travel pattern analysis, according to an embodiment. A user can run a travel pattern analysis app 124, as shown in step 201. The travel pattern analysis can be stored in the memory 124 of the user device 120. The travel pattern analysis can be stored in any other memory. The user can run the travel pattern analysis app 124 by selecting an icon, such as on a screen of the user device.

The user can travel, e.g., drive, take public transportation, and/or walk, from home to work and vice versa every day for five weekdays, as shown in step 202. The user can drive to a restaurant for lunch. The user can drive for routine errands. The time can be varied, as desired by the user. The user can travel, e.g., drive, take public transportation, and/or walk, from home to any other place. Generally, the travel pattern analysis system can use habitual or repetitive travel to determine travel patterns.

The user can travel on vacation or for any other reason. The travel pattern analysis can be used for long term travel patterns, such as those that repeat over a period of days, weeks, months or years, such as to and from work. The travel pattern analysis can be used for short term travel patterns, such as those associated with visits, vacations, and the like.

GPS information regarding the user's location on the way to and from work can be communicated to a travel pattern analysis system, as shown in step 203. The GPS information can be from the GPS 123 of the user device 120. The GPS information can be from any other device.

The travel pattern analysis system can determine the user's travel pattern for the five weekdays, as shown in step 204. The user's travel pattern can be a route, such as the route taken to and/or from work. The user's travel pattern can be an average of different routes, such as when the user takes different routes to and/or from work.

The user's travel pattern need not correspond to a real route, e.g., a street route or a walking route. The user's travel pattern can be an average can be between real routes. The user's travel pattern can substantially be an “as the bird flies” route. The user's travel pattern can be any route that can be used to identify places of interest to the user.

The travel pattern analysis system can determine alternative routes for the user's trip to and from work, as shown in step 205. One or more alternative routes can be determined. An alternative route can be a completely new route or can be a partially new route.

The travel pattern analysis system can determine places of interest along the alternative routes, as shown in step 206. One or more places of interest can be along each alternative route. Any number of places of interest can be determined along each route.

The places of interest can be communicated to the user, as shown in step 207. The places of interest can be communicated to the user via the app 124, via email, text messaging, a notification to visit a website, voice, or any other method.

FIG. 3 is a flow chart showing further detail of the method for travel pattern analysis, according to an embodiment. Information about an account of a user can be stored in one or more memories, as shown in step 301. The information can include one or more purchase histories, one or more wish lists, one or more likes, one or more emails, one or more blog entries, or the like. The information can be indicative of the user interests.

The information can include travel information of the user. For example, the information can include a route that the user routinely follows to and from work. The information can include routes that the user routinely follows to and from places to eat. The information can include routes that the user routinely follows when performing errands, such as routes to a local drug store, a local department store, a gas station, and a garage.

A first communication including an indication of a user's travel pattern can be received, via one or more hardware processors, as shown in step 302. The first communication can be received as a result of the user running the app 124 and the app 124 recording the user's actual travel according to the GPS 123 of the user device 120.

Places of interest to the user proximate the user's travel pattern can be determined via the one or more hardware processors and at least in part from the user's travel pattern, as shown in step 303. For example, the one or more processors can provide the average of the users travel (which can be the same as the user's travel) to define the user's travel pattern. The places of interest can be places of interest that are on the same routes, that are on nearby routes, or that are located within the general area of the user's travel pattern.

A second communication can be sent to the user including an indication of what the places of interest are and where the places of interest are located, as shown in step 304. The second communication can be to the user device 120. The second communication can be to any other device accessible by the user.

The one or more memories and/or the one or more processors can be one or more memories and/or the one or more processors of the merchant device, 110, the user device 120, the server 130, the social network 150, and/or any other device or system. Memories and/or processors from any number of devices, systems, and entities can cooperate to perform the travel patter analysis method disclosed herein.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Payment processing can be through known methods, such as transaction details being communicated to the payment provider through the app, the payment provider processing the details, which may include user account and identifier information and authentication, merchant information, and transaction details. The user account may be accessed to determine if any restrictions or limitations may prevent the transaction from being approved. If approved, the payment provider may send a notification to the merchant and/or the user.

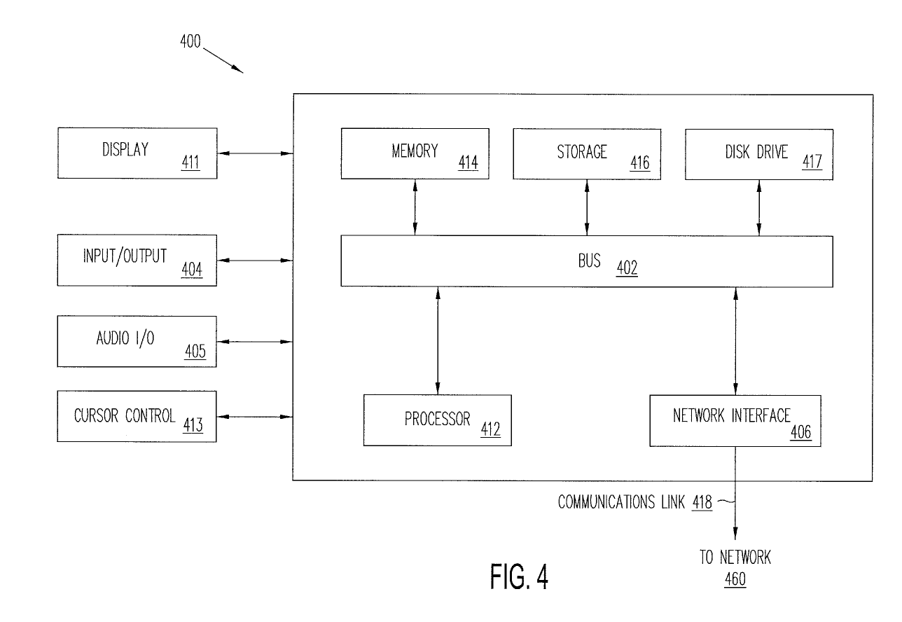

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

As used herein, the term “store” can include any business or place of business. The store can be a brick and mortar store or an online store. Examples of stores can include supermarkets, discount stores, book stores, convenience stores, restaurants, gas stations, auto repair shops, and movie theaters. The store can be any person or entity that sells a product or provides a service.

As used herein, the term “product” can include any item or service. Thus, the term “product” can refer to physical products, digital goods, services, or anything for which a user can make a payment, including charitable donations. A product can be anything that can be sold. Examples of products include cellular telephones, concerts, meals, hotel rooms, automotive repair, haircuts, digital music, and books. The product can be a single item or a plurality of items. For example, the product can be a tube of toothpaste, a box of laundry detergent, three shirts, and a donut.

As used herein, the term “merchant” can include any seller of products. The term merchant can include a store. The products can be sold from a store or in any other manner.

As used herein, the term “mobile device” can include any portable electronic device that can facilitate data communications, such as via a cellular network and/or the Internet. Examples of mobile devices include cellular telephones, smart phones, tablet computers, and laptop computers.

As used herein, the term “network” can include one or more local area networks (LANs) such as business networks, one or more wide area networks (WANs) such as the Internet, one or more cellular telephone networks, or any other type or combination of electronic or optical networks.

As used herein, the term “card” can refer to any card or other device that can be used to make a purchase in place of cash. For example, the card can be a bank card, credit card, debit card, gift card, or other device. The card can be a token, such as a hardware token or a software token. The card can be stored in and/or displayed upon a user device, such as a cellular telephone.

According to one or more embodiments, a user's travel patterns can be analyzed. The analyzed travel patterns can provide information to the user that encourages the user, e.g., a consumer, to explore and spend. New stores, restaurants, and the like can be readily found and explored by the user. The user is more likely to find products of interest and to purchase such products.

The foregoing disclosure is not intended to limit the present invention to the precise forms or particular fields of use disclosed. It is contemplated that various alternative embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

1. A system comprising:
one or more memories storing information about an account of a user, wherein the information comprises travel patterns for the user;
one or more hardware processors in communication with the one or more memories and operable to:
receive a first communication including an indication of a user's travel pattern;
determine, at least in part from the user's travel pattern, a place of interest to the user located on a route proximate the user's travel pattern, wherein only routes proximate the user's travel pattern that meet a predetermined criteria are considered as having one or more places of interest to the user; and
send a second communication to the user including an indication of what the place of interest is and where the place of interest is located.

2. The system of claim 1, wherein determining the place of interest to the user comprises:
determining at least one alternative route with respect to the user's travel pattern; and
determining at least one place of interest along the at least one alternative route.

3. The system of claim 2, wherein determining the at least one alternative route to the user's travel pattern comprises determining at least one alternative route to the user's travel pattern that meets the predetermined criteria, wherein the predetermined criteria comprises increasing a drive time of the user by less than a predetermined amount, and the alternative route(s) is considered as having a place(s) of interest to the user.

4. The system of claim 2, wherein determining the at least one place of interest along the at least one alternative route comprises ascertaining interests of the user, which are determined based on accessing at least one of a purchase history, a wish list, and likes of the user.

5. The system of claim 2, wherein determining the at least one place of interest along the at least one alternative route comprises determining the user's travel pattern via an app that monitors the user's travel for a predetermined amount of time.

6. The system of claim 1, wherein:
the user's travel pattern is determined using a GPS enabled mobile device of the user; and
the first communication is sent to the one or more processors by the GPS enabled mobile device.

7. The system of claim 1, wherein the place of interest is determined, at least in part, based on an amount of time the user spends at a location along the user's travel pattern.

8. A method comprising:
storing, in one or more memories, information about an account of a user, wherein the information comprises travel patterns for the user;
receiving, via one or more hardware processors, a first communication including an indication of a user's travel pattern;
determining, via the one or more hardware processors, at least in part from the user's travel pattern, a place of interest to the user located on a route proximate the user's travel pattern, wherein only routes proximate the user's travel pattern that meet a predetermined criteria are considered as having one or more places of interest to the user; and
sending, via the one or more hardware processors, a second communication to the user including an indication of what the place of interest is and where the place of interest is located.

9. The method of claim 8, wherein determining the place of interest to the user comprises:
determining at least one alternative route with respect to the user's travel pattern; and
determining at least one place of interest along the at least one alternative route.

10. The method of claim 9, wherein determining the at least one alternative route to the user's travel pattern comprises determining at least one alternative route to the user's travel pattern that meets the predetermined criteria, wherein the predetermined criteria comprises increasing a drive time of the user by less than a predetermined amount, and the alternative route(s) is considered as having a place(s) of interest to the user.

11. The method of claim 9, wherein determining the at least one place of interest along the at least one alternative route comprises ascertaining interests of the user, which are determined based on accessing at least one of a purchase history, a wish list, and likes of the user.

12. The method of claim 9, wherein determining the at least one place of interest along the at least one alternative route comprises determining the user's travel pattern via an app that monitors the user's travel for a predetermined amount of time.

13. The method of claim 8, wherein:
the user's travel pattern is determined using a GPS enabled mobile device of the user; and
the first communication is sent to the one or more processors by the GPS enabled mobile device.

14. The method of claim 8, wherein the place of interest is determined, at least in part, on an amount of time the user spends at a location along the user's travel pattern.

15. A computer program product comprising a non-transitory computer readable medium having computer readable and executable code for instructing one or more processors to perform a method, the method comprising:
storing information about an account of a user, wherein the information comprises travel patterns for the user;
receiving a first communication including an indication of a user's travel pattern;
determining at least in part from the user's travel pattern, a place of interest to the user located on a route proximate the user's travel pattern, wherein only routes proximate the user's travel pattern that meet a predetermined criteria are considered as having one or more places of interest to the user; and
sending a second communication to the user including an indication of what the place of interest is and where the place of interest is located.

16. The method of claim 15, wherein determining the place of interest to the user comprises:
determining at least one alternative route with respect to the user's travel pattern; and
determining at least one place of interest along the at least one alternative route.

17. The method of claim 16, wherein determining the at least one alternative route to the user's travel pattern comprises determining at least one alternative route to the user's travel pattern that meets the predetermined criteria, wherein the predetermined criteria comprises increasing a drive time of the user by less than a predetermined amount, and the alternative route(s) is considered as having a place(s) of interest to the user.

18. The method of claim 16, wherein determining the at least one place of interest along the at least one alternative route comprises ascertaining interests of the user, which are determined based on accessing at least one of a purchase history, a wish list, and likes of the user.

19. The method of claim 16, wherein determining the at least one place of interest along the at least one alternative route comprises determining the user's travel pattern via an app that monitors the user's travel for a predetermined amount of time.

20. The method of claim 15, wherein:
the user's travel pattern is determined using a GPS enabled mobile device of the user; and
the first communication is sent to the one or more processors by the GPS enabled mobile device.

21. The method of claim 15, wherein the place of interest is determined, at least in part, on an amount of time the user spends at a location along the user's travel pattern.
